(19) United States
(12) Patent Application Publication
(10) Pub. No.: US 2010/0068935 A1
(43) Pub. Date: Mar. 18, 2010

(54) Connector module

(76) Inventor: Chun-Chi Chou, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/232,329

(22) Filed: Sep. 16, 2008

(51) Int. Cl. H01R 13/66

(52) U.S. Cl. 439/620.22

(57) ABSTRACT

The present invention provides an improved connector module, including a housing forming two receptacle chambers and having an end face retaining a conductor and an opposite end face forming wire retention sections communicating the receptacle chambers, and upper and lower surfaces of the housing forming recesses; two connectors respectively received in the receptacle chambers and each comprising a socket portion, a metal casing, and conductive wires connected to the socket portion and extending through the respective wire retention section; and a metal enclosure enclosing the housing and physically engaging the conductor and having top and bottom walls forming resilient tabs received in the recesses of the housing and an end wall forming openings corresponding to the connectors. The connector module features easy mounting/dismounting, increased grounding area and enhanced impedance to thereby provide enhanced EMI performance.

### FIELD OF THE INVENTION

The present invention relates to an improved connector module, and in particular to an connector module featuring easy mounting/dismounting, increased grounding area and enhanced impedance to thereby provide enhanced EMI (electromagnetic interference) performance.

### BACKGROUND OF THE INVENTION

A computer device is often equipped with connectors for connection external devices. Such connectors can be mounted to an edge of a main board in such a way that mating surfaces or openings of the connectors are exposed through a wall of the computer enclosure to allow plugging of the external devices to the connectors on the wall of the computer enclosure for expansion of the hardware and functionality of the computer in a convenient manner.

Although convenient connection with the external devices can be easily realized through the connectors exposed on the wall of the computer enclosure, yet the connectors that are mounted to the main board of the computer are not allowed to easily dismount from the main board. Thus, when a connector is broken or fails to properly function, it is generally impossible for a regular computer user to replace the broken connector and the computer has to be returned to the factory for maintenance and repairing. This makes the maintenance and repairing difficult for the general consumers. Further, since the conventional connectors are often set in physical engagement with the computer enclosure, which is considered a grounding potential, with a metal casing thereof, the grounding area of the connectors is apparently very small and the impedance thereof cannot be enhanced, eventually leading to poor electromagnetic shielding and affecting performance of the connectors. Thus, the conventional connectors provided for computers do not suit practical needs of using computers.

### SUMMARY OF THE INVENTION

An objective of the present invention is to provide a connector module featuring easy mounting/dismounting, increased grounding area and enhanced impedance to thereby provide enhanced EMI performance.

To realize the above objective, the present invention provides an improved connector module, comprising a housing, which forms two receptacle chambers, an end face of the housing forming a notch communicating between the receptacle chambers and retaining therein a conductor, the housing having an opposite end face forming wire retention sections in communication with the receptacle chambers, upper and lower surfaces of the housing forming recesses; two connectors respectively received in the receptacle chambers and each comprising a socket portion, a metal casing encasing the socket portion and in physical engagement with the conductor, and conductive wires connected to the socket portion and extending through the respective wire retention section; and a metal enclosure enclosing the housing and having an inside surface in physical engagement with the conductor, the metal enclosure having top and bottom walls forming resilient tabs received in and engaging the recesses of the housing, an end wall of the metal enclosure forming openings corresponding to the connectors.

### BRIEF DESCRIPTION OF THE DRAWINGS

The present invention will be apparent to those skilled in the art by reading the following description of preferred embodiments thereof with reference to the drawings, in which:

FIG. 1 is a perspective view of an connector module constructed in accordance with the present invention;

FIG. 2 is a front-side exploded view of the connector module of the present invention;

FIG. 3 is a rear-side exploded view of the connector module of the present invention; and

FIG. 4 illustrates an application of the connector module of the present invention.

### DETAILED DESCRIPTION OF THE PREFERRED EMBODIMENT

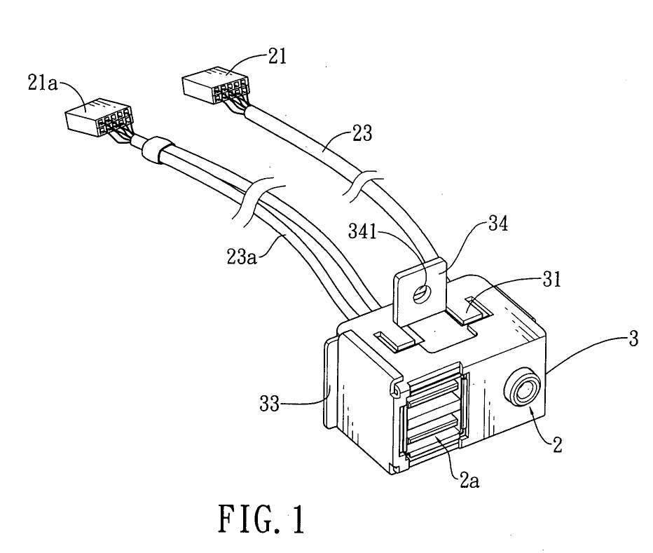

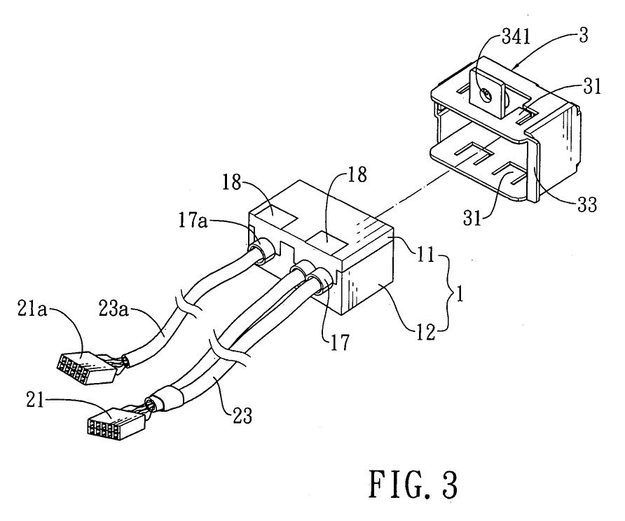

With reference to the drawings and in particular to FIGS. 1-3, which respectively show a perspective view, a front-side exploded view, and a rear-side exploded view of an connector constructed in accordance with the present invention, as shown, the present invention provides an improved connector, comprising a housing 1, two connectors 2, 2a, and a metal enclosure 3.

The housing 1 is comprised of an upper member 11 and a lower member 12. The upper member 11 forms a plurality of mounting poles 111 extending from an inside surface thereof, while the lower member 12 forms a plurality of cylinders 121 defining fitting holes corresponding to in position and quantity to the mounting poles 111. The housing 1 defines therein two receptacle chambers 13, 14 that juxtapose each other and communicates an end face of the housing 1. The housing 1 has an end face forming a notch 15 communicating between the receptacle chambers 13, 14. A conductor 16 made of electrically conductive foaming material is arranged in the notch 15. The housing 1 also has an opposite end face that forms wire retention sections 17, 17a defining therein passages in communication with the receptacle chambers 13, 14. The housing 1 has upper and lower surfaces in which recesses 18 are defined.

The connectors 2, 2a are received in the receptacle chambers 13, 14 respectively. Each connector 2, 2a is comprised of a socket portion 21, 21a, a metal casing 22, 22a encasing the socket portion 21, 21a and physically engaging the conductor 16, and conductive wires 23, 23a electrically connected to the socket portion 21, 21a and extending through the passages defined in the wire retention sections 17, 17a. The connectors 2, 2a can be for example an audio signal connector and a USB (Universal Serial Bus) connector, respectively. The USB connector can be a single-layer USB connector or a double-layer USB connector.

The metal enclosure 3 encloses outer surfaces of the housing 1 and an inside surface physically engaging the conductor 16. The metal enclosure 3 has top and bottom walls respectively forming resilient tabs 31 that are respectively received in and engage the recesses 18. The metal enclosure 3 has an end wall forming opening 32, 32a corresponding to the connectors 2, 2a. A side wall of the metal enclosure 3 forms a sideways projecting stop flange 33. The metal enclosure 3 also forms at a location approximate a resilient tab 31 in a wall thereof a wing tab 34 that defined a mounting hole 341. As such, with the above described construction, a novel, improved connector module is provided.

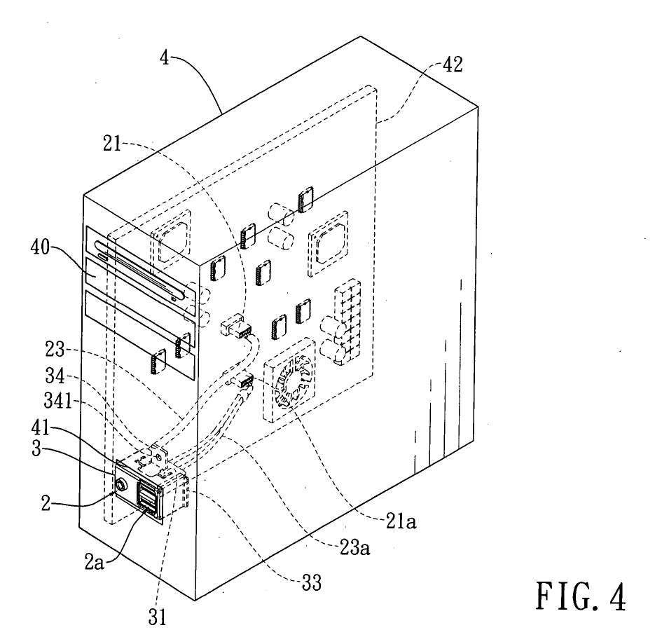

Referring to FIG. 4, which illustrates an application of the connector module of the present invention, as shown, in the application of being mounted to a computer, the connector module of the present invention can be selectively mounted to either a front surface or a rear surface of a computer enclosure 4. An example of mounting the connector module to the front panel 40 on the front surface of the computer enclosure 4 will be described hereinafter to describe the present invention. To mount the connector module to the computer enclosure 4, the connector module of the present invention is first positioned, either inside or outside the computer enclosure, in registration with an opening 41 defined in the front panel 40 of the computer enclosure 4 and the stop flange 33 of the metal enclosure 3 of the connector module is set in abutting engagement with a circumferential edge of the opening 41. The wing tab 34 is then secured to the front panel 40 with a fastener (not shown) received through the mounting hole 341. The wires 23, 23a of the connectors 2, 2a are set in electrical connection with a main board 42 of the computer. As such, the assembling of the connector module of the present invention to the computer is completed. On the other hand, to remove the connector module of the present invention from the computer front panel, the fastener is loosened and the wires 23, 23a of the connectors 2, 2a are released from the computer main board 42. Then, the connector module can be removed. Thus, the present invention features easy mounting/dismounting.

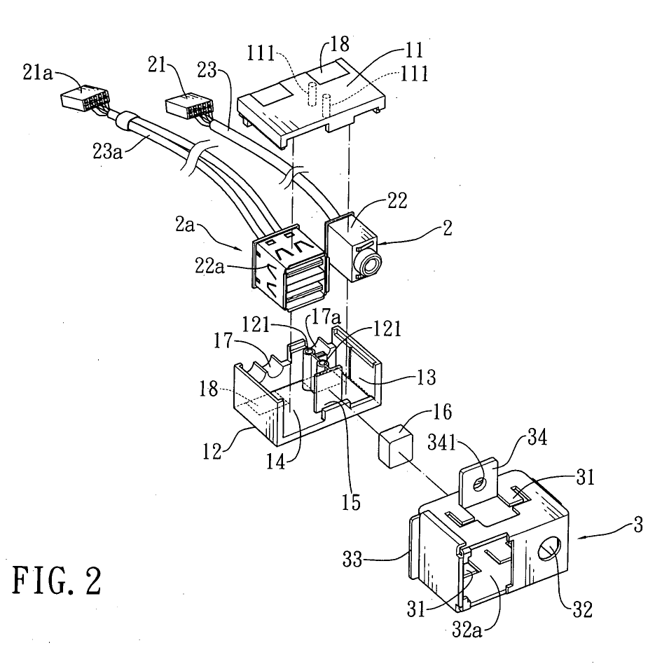

To use the connector module mounted to the computer, with reference to FIGS. 1 and 2, a plug connector of a peripheral device of the computer is directly inserted into the corresponding socket portion 21, 21a of the connector 2, 2a to allow establishment of electrical conduction for signal transmission with the socket portion 21, 21a. When signal transmission is in progress between the socket portion 21, 21a of the connector module and the external peripheral device, the physical engagement between the conductor 16 and the metal casings 22, 22a and the metal enclosure 3 allows for increase of grounding area for both connectors 2, 2a and enhancement of impedance thereof, whereby enhanced EMI performance can be realized for the operation of each connector 2 and the expanded connector 3.

To conclude, the improved connector module in accordance with the present invention features easy mounting/dismounting of the electric connector module and also increases grounding area and enhances impedance, so that improved EMI performance can be realized in the operation thereof.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An connector module, comprising:
a housing, which forms two juxtaposing receptacle chambers communicating an end face of the housing, an end face forming a notch communicating between the receptacle chambers, a conductor being arranged in the notch, the housing having an opposite end face forming wire retention sections in communication with the receptacle chambers, upper and lower surfaces of the housing forming recesses;
two connectors respectively received in the receptacle chambers and each comprising a socket portion, a metal casing encasing the socket portion and in physical engagement with the conductor, and conductive wires connected to the socket portion and extending through the respective wire retention section; and
a metal enclosure enclosing the housing and having an inside surface in physical engagement with the conductor, the metal enclosure having top and bottom walls forming resilient tabs received in and engaging the recesses of the housing, an end wall of the metal enclosure forming openings corresponding to the connectors.

2. The connector module as claimed in claim 1, wherein the housing comprises an upper member and a lower member, the upper member forming a plurality of mounting poles extending from an inside surface thereof, the lower member forming a plurality of fitting holes corresponding to the poles.

3. The connector module as claimed in claim 1, wherein the conductor is made of electrically conductive foaming materials.

4. The connector module as claimed in claim 1, wherein the two connectors are respectively an audio signal and a universal serial bus connector.

5. The connector module as claimed in claim 4, wherein the universal serial bus connector comprises a single-layered universal serial bus connector.

6. The connector module as claimed in claim 4, wherein the universal serial bus connector comprises a double-layered universal serial bus connector.

7. The connector module as claimed in claim 1, wherein the metal enclosure has a side wall from which a stop flange projects sideways and wherein the metal enclosure forms a wing tab at a location close to one of the resilient tab in a wall thereof, the wing tab forming a mounting hole.
